(19) United States
(12) Patent Application Publication
(10) Pub. No.: US 2008/0270022 A1
(43) Pub. Date: Oct. 30, 2008

(54) Method for positioning at least one reporting point on a flight track

(75) Inventors: Emmanuel Dewas, Toulouse (FR); Valerie Bataillon, Colomiers (FR); Francois Hoofd, Toulouse (FR)

Correspondence Address: LOWE HAUPTMAN & BERNER, LLP, 1700 DIAGONAL ROAD, SUITE 300, ALEXANDRIA, VA, 22314, US

(73) Assignee: THALES, Neuilly Sur Seine (FR)

(21) Appl. No.: 12/107,868

(22) Filed: Apr. 23, 2008

(30) Foreign Application Priority Data
Apr. 27, 2007 (FR) 07 02972

(51) Int. Cl. G01C 21/00

(52) U.S. Cl. 701/206; 701/200

(57) ABSTRACT

The invention relates to a method for positioning reporting points that allows an exact positioning of the said reporting points on the track to be conserved, by continually using their original references in order to reposition these points each time the track is recalculated. The advantages of this solution are, on the one hand, to continually position the reporting points along the track rather than off the track and, thus, to locate the reporting points exactly notably in terms of distance, time and altitude.

### RELATED APPLICATIONS

The present application is based on, and claims priority from, French Application Number 07 02972, filed Apr. 24, 2007, the disclosure of which is hereby incorporated by reference herein in its entirety.

### FIELD OF THE INVENTION

The invention relates to systems for flight management of an aircraft and, more particularly, the calculation of reporting points on its track.

### BACKGROUND OF THE INVENTION

Reporting points are points, calculated during the preparation of a flight or else during the flight, situated on the track of an aircraft. These reporting points are fixed points where the pilot carries out predetermined actions such as a call to air traffic control. The position of these points is defined in a manner relative to a fixed reference point which can for example be a VOR (Very High Frequency Omnidirectional Range) beacon. The aircraft comprises a navigational database in which potential points of reference are identified. The aircraft also comprises an FMS (Flight Management System) notably enabling a track and predictions (in terms of distance, time, altitude, etc.) associated with the reporting points to be calculated.

The reporting points can notably be defined using: an intersection between a radial (known as RADIAL FIX INFO) and the track, an intersection between a circle (known as CIRCLE FIX INFO) and the track, an orthogonal projection from a point (known as ABEAM) or from a point positioned in relative distance from a reference point (known as ATO).

According to the prior art, when these reporting points are created they are calculated with a position defined by a latitude and a longitude, along the track calculated by the flight management system or FMS. However, in the course of the flight, the track may be refreshed in order to take account of new parameters of the aircraft such as the speed, of environmental changes (weather, wind, etc.) or of the definition of a parallel track displaced from the reference flight plan (known as OFFSET). As a result, when the track is modified, the reporting points previously calculated are no longer positioned on the track.

According to the prior art, the FMS estimates the positioning of these reporting points, as it does with all the points of the flight plan, by calculating the orthogonal projection of the point onto the track. This has the drawback of not positioning the reporting points such as they were defined when they were created and of falsifying the predictions.

### SUMMARY OF THE INVENTION

The invention aims to overcome the aforementioned problems by providing a method for positioning reporting points that allows an exact positioning of the said reporting points on the track to be conserved, by continually using their original references in order to reposition these points each time the track is recalculated. The advantages of this solution are, on the one hand, to continually position the reporting points along the track rather than off the track and, on the other hand, to locate the reporting points exactly notably in terms of distance, time and altitude.

For this purpose, the subject of the invention is a method for positioning at least one reporting point on a modified track flown by an aircraft, the said modified track being obtained by carrying out at least one modification on an initial track of the said aircraft, the said aircraft comprising a navigational database, the said reporting point being defined by at least one reference characteristic comprising a reference point identified in the navigational database, the said reporting point being situated at an initial position on the said initial track, characterized in that it comprises the following steps:
the storage of the reference characteristic(s) of the reporting point comprising the identifier of the reference point in the navigational database, when the reporting point is created,
the displacement of the reporting point from its initial position towards a new position, when the track is modified, the said new position being determined using the stored reference characteristic.

According to one variant of the invention, the position of the said reporting point is calculated using a radial defined by a course and a reference point. The stored reference characteristics comprise the identifier of the reference point of the radial and also the course of the radial, and the said new position is furthermore determined by the intersection between the modified track and the radial.

According to one variant of the invention, the position of the said reporting point is calculated using a circle defined by a radius and a reference point. The stored reference characteristics comprise the identifier of the reference point of the circle and also the radius of the said circle, and the said new position is furthermore determined by the intersection between the modified track and the circle.

According to one variant of the invention, the position of the said reporting point is calculated using an orthogonal projection of a reference point. The stored reference characteristics comprise the identifier of the reference point, and the said new position is furthermore determined by the projection of the reference point onto the new track.

According to one variant of the invention, the position of the said reporting point is calculated using a relative distance to a reference point, the said reference point being a waypoint on the track. The stored reference characteristics comprise the identifier of the reference point and also the relative distance, and the said new position is determined using the stored relative distance and the reference point.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements have the same reference numeral designations represent like elements throughout and wherein:

FIG. 1a shows a first example where a reporting point is situated at an initial position on an initial track of an aircraft.

FIG. 1b presents a modified track obtained after modification of the initial track together with the positioning of the reporting point calculated with a method according to the prior art and with the method according to the invention.

FIG. 2 shows a reporting point calculated, with the method according to the invention, using the intersection between a circle and a modified track.

FIG. 3 shows a reporting point calculated, with the method according to the invention, using an orthogonal projection of a reference point onto a modified track.

FIG. 4 shows a reporting point calculated, with the method according to the invention, using a distance to a reference point.

### DETAILED DESCRIPTION OF THE INVENTION

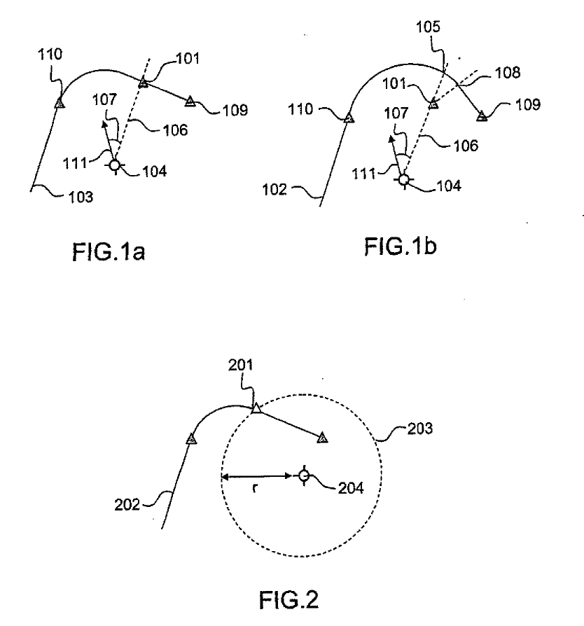

FIG. 1a shows a first example where a reporting point is situated at an initial position 101 on an initial track 103 of an aircraft notably defined starting from waypoints 109, 110. The said reporting point is situated at the intersection of the initial track 103 and of a radial 106 defined using a reference point 104 and a course 107 indicating the orientation of the said radial with respect to an axis 111 oriented towards the north.

FIG. 1b presents a modified track 102 obtained after modification of the initial track 103. The initial position 101 of the reporting point is not on the modified track. A new position for the reporting point has to be calculated in such a manner as to situate it on the modified track 102. A method according to the prior art consists in storing the initial position 101 of the reporting point when the latter is created then in calculating an estimated position 108 by the orthogonal projection of the said reporting point onto the modified track 103. When the said track is an arc of a circle, the estimated position 108 is defined as the intersection between the circular arc and the straight line passing through the centre of the circle and the position 101. This solution is an approximation which has the drawback of causing a loss of precision in the predictions (notably in terms of position, distance, time and altitude) when the said aircraft flies over the said reporting point.

The method according to the invention consists, during a first step, in storing the identifier of the reference point and reference characteristics of the reporting point (in our example, the course of the radial) in the navigational database, when the said reporting point is created. The second step of the method according to the invention consists in calculating a new position by the intersection between the modified track 102 and the stored reference characteristics of the reporting point. The new calculated position 105 is then the exact position desired by the pilot.

In the following paragraphs, we will consider different variants of the method according to the invention.

FIG. 2 shows a position 201 of a reporting point calculated, with the method according to the invention, using the intersection between a circle 203 and a modified track 202. The said circle is defined by a radius r and a reference point 204 (the centre of the circle). The first step of the method according to the invention consists in storing the radius r of the said circle and the identifier of its reference point 204 in the navigational database. The second step of the method according to the invention consists in calculating the new position 201 of the reporting point by the intersection between the modified track 202 and the circle 203 defined by the information stored in the preceding step.

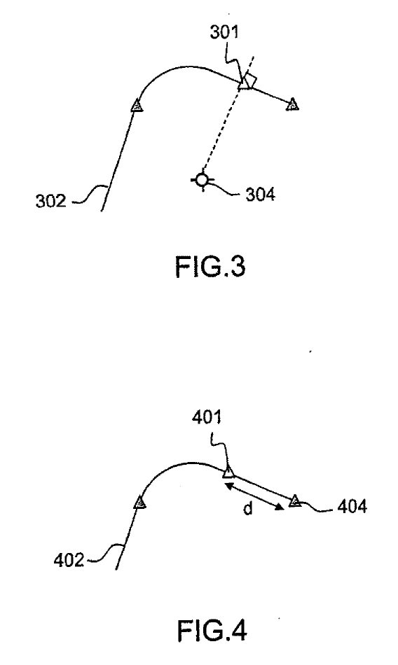

FIG. 3 shows a position 301 of a reporting point calculated, with the method according to the invention, using an orthogonal projection of a reference point 304 onto a modified track 302. The first step of the method according to the invention consists in storing the identifier of the reference point 304 in the navigational database. The second step of the method according to the invention consists in calculating the new position 301 of the reporting point by the orthogonal projection of the reference point 304 whose identifier has been stored in the preceding step. When the said track is an arc of a circle, the estimated position is defined as the intersection between the circular arc and the straight line passing through the centre of the circle and the position 304.

FIG. 4 shows a position 401 of a reporting point calculated, with the method according to the invention, using a distance d to a reference point 404 on a modified track 402. The first step of the method according to the invention consists in storing the distance d and the identifier of the reference point 404 in the navigational database. The second step of the method according to the invention consists in calculating the new position 401 of the reporting point using the distance d and the identifier of the reference point 404 stored in the preceding step.

According to one aspect of the invention, the method for positioning at least one reporting point also comprises a step for calculating a track and predictions, notably relating to time, altitude, speed, fuel and wind, associated with the said reporting point. Based on the characteristics of the waypoints defined by the pilot during the preparation of the flight together with the characteristics of the performance of the aircraft, the system calculates a set of straight and circular arc segments (called ‘Legs’) passing through the waypoints defined by the pilot, together with the predictions at the various waypoints (time, altitude, speed, fuel and wind).

According to one aspect of the invention, the method for positioning at least one reporting point also comprises a step for creating and transmitting a warning message, when the reporting point cannot be calculated. This is the case, for example, when there is no longer an intersection between a radial and the modified track. A warning message is then sent to the pilot in order to inform him that the reporting point has been lost. This message can contain the characteristics of the reporting point in order to allow the pilot to identify the reporting point that has been lost. The reporting point is then displayed at its last known position by a particular symbol or colour.

According to one aspect of the invention, when the reporting point is used by the pilot to modify the track, the said reporting point is no longer repositioned and remains fixed. The reporting point then becomes a waypoint and its absolute position (latitude, longitude) is definitively fixed and is used in the calculation of the track.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A method for positioning at least one reporting point on a modified track flown by an aircraft, the modified track being obtained by carrying out at least one modification on an initial track of the aircraft, the aircraft comprising a navigational database, the reporting point being defined by at least one reference characteristic comprising a reference point identified in the navigational database, the reporting point being situated at an initial position on the initial track, comprising the following steps:
the storing the reference characteristic(s) of the reporting point comprising the identifier of the reference point in the navigational database, when the reporting point is created,
displacing the reporting point from its initial position towards a new position, when the track is modified, the new position being determined using the stored reference characteristic.

2. The method for positioning at least one reporting point according to claim 1, wherein, since the position of the reporting point is calculated using a radial defined by a course and a reference point, the stored reference characteristics comprise the identifier of the reference point of the radial and also the course of the radial, and in that the new position is furthermore determined by the intersection between the modified track and the radial.

3. The method for positioning at least one reporting point according to claim 1, wherein, since the position of the reporting point is calculated using a circle defined by a reference point and a radius (r), the stored reference characteristics comprise the identifier of the reference point of the circle and also the radius (r) of the said circle, and in that the new position is furthermore determined by the intersection between the modified track and the circle.

4. The method for positioning at least one reporting point according to claim 1, wherein, since the position of the reporting point is calculated using an orthogonal projection of a reference point, the stored reference characteristics comprise the identifier of the reference point, and in that the new position is furthermore determined by the projection of the reference point onto the new track.

5. The method for positioning at least one reporting point according to claim 1, wherein, since the position of the reporting point is calculated using a relative distance (d) to a reference point, the reference point being a waypoint on the track, the stored reference characteristics comprise the identifier of the reference point and also the relative distance (d), and in that the new position is determined using the stored relative distance (d) and the reference point.

6. The method for positioning at least one reporting point according to claim 1, comprising a step for calculating predictions associated with the reporting point, the reporting point being associated with predictions notably relating to time and altitude, speed, fuel and wind.

7. The method for positioning at least one reporting point according to claim 1, comprising a step for creating and transmitting a warning message, when the reporting point cannot be calculated.

8. The method for positioning at least one reporting point according to claim 1, wherein when the reporting point is used by the pilot to modify the track, the reporting point is no longer re-positioned and remains fixed.

9. The method for positioning at least one reporting point according to claim 2, comprising a step for calculating predictions associated with the reporting point, the reporting point being associated with predictions notably relating to time and altitude, speed, fuel and wind.

10. The method for positioning at least one reporting point according to claim 3, comprising a step for calculating predictions associated with the reporting point, the reporting point being associated with predictions notably relating to time and altitude, speed, fuel and wind.

11. The method for positioning at least one reporting point according to claim 4, comprising a step for calculating predictions associated with the reporting point, the reporting point being associated with predictions notably relating to time and altitude, speed, fuel and wind.

12. The method for positioning at least one reporting point according to claim 5, comprising a step for calculating predictions associated with the reporting point, the reporting point being associated with predictions notably relating to time and altitude, speed, fuel and wind.

13. The method for positioning at least one reporting point according to claim 2, comprising a step for creating and transmitting a warning message, when the reporting point cannot be calculated.

14. The method for positioning at least one reporting point according to claim 3, comprising a step for creating and transmitting a warning message, when the reporting point cannot be calculated.

15. The method for positioning at least one reporting point according to claim 4, comprising a step for creating and transmitting a warning message, when the reporting point cannot be calculated.

16. The method for positioning at least one reporting point according to claim 5, comprising a step for creating and transmitting a warning message, when the reporting point cannot be calculated.

17. The method for positioning at least one reporting point according to claim 6, comprising a step for creating and transmitting a warning message, when the reporting point cannot be calculated.

18. The method for positioning at least one reporting point according to claim 2, wherein when the reporting point is used by the pilot to modify the track, the reporting point is no longer re-positioned and remains fixed.

19. The method for positioning at least one reporting point according to claim 3, wherein when the reporting point is used by the pilot to modify the track, the reporting point is no longer re-positioned and remains fixed.

20. The method for positioning at least one reporting point according to claim 4, wherein when the reporting point is used by the pilot to modify the track, the reporting point is no longer re-positioned and remains fixed.
